(19) United States
(12) Patent Application Publication
(10) Pub. No.: US 2008/0102874 A1
(43) Pub. Date: May 1, 2008

(54) CONTROL OF TRANSMIT POWER OF A SECOND TRANSMITTER BASED ON ANTENNA LOADING PARAMETERS MEASURED ON A FIRST TRANSMITTER

(75) Inventors: Roberto Gautier, Davie, FL (US); Jason T. Young, Palm City, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/553,999

(22) Filed: Oct. 28, 2006

(51) Int. Cl. H04B 1/04; H04B 7/00; H01Q 11/12

(52) U.S. Cl. 455/522; 455/127.1

(57) ABSTRACT

A method (300) of controlling transmit power of a communication device (100). The method can include, on a first transmitter (105), measuring at least one parameter that corresponds to a loading characteristic of an antenna (115) operatively coupled to the first transmitter. An antenna load indicator (160) that is based on the parameter can be generated. The antenna load indicator can be communicated from a first processor (140) operatively coupled to the first transmitter to a second processor (145) operatively coupled to a second transmitter (110). The second transmitter also can be operatively coupled to the antenna. Based on the measured parameter, a transmit power of the second transmitter can be selectively controlled.

### BACKGROUND OF THE INVENTION

1. Field of the Invention

The present invention generally relates to communication devices and, more particularly, to mobile stations having a plurality of transmitters.

2. Background of the Invention

The use of mobile stations has grown to an extent that such devices are now ubiquitous throughout most of the industrialized world. Just as their use has grown, so too has the functionality of mobile stations. Indeed, mobile stations now can be used not only for voice communications, but also to perform a number of other tasks. For example, mobile stations can be used to take photographs, capture and stream video, browse the Internet, play games, and send and receive instant messages and e-mail. Moreover, mobile stations can simultaneously perform a plurality of such functions. For example, while a user is engaged in a telephone conversation using a first transceiver on a mobile station, the user also can send and receive data in multiple formats using a second transceiver. For instance, the user can browse the Internet, communicate data files and communicate via e-mail.

Unfortunately, simultaneous use of both transceivers can result in rapid depletion of battery resources and generation of a significant amount of thermal energy (i.e. heat). When the mobile station is being held, such heat can be uncomfortable for a user.

### SUMMARY OF THE INVENTION

The present invention relates to a method of controlling transmit power of a communication device. The method can include, on a first transmitter, measuring at least one parameter that corresponds to a loading characteristic of an antenna operatively coupled to the first transmitter. In one aspect of the invention, measuring the parameter can include measuring an insertion phase delay, a power compression or a gain of the transmitter. In another aspect of the invention, measuring the parameter can include measuring a voltage standing wave ratio (VSWR) or an amount of signal reflection. An antenna load indicator can be generated. The antenna load indicator can be based on the parameter. The antenna load indicator can be communicated from a first processor operatively coupled to the first transmitter to a second processor operatively coupled to a second transmitter. The second transmitter also can be operatively coupled to the antenna.

Based on the measured parameter, a transmit power of the second transmitter can be selectively controlled. For example, the transmit power can be limited. In one arrangement, the transmit power can be limited in response to the parameter indicating a loading of the antenna exceeding a threshold value. The transmit power also can be selectively changed. For example, the transmit power can be selectively changed in response to the parameter indicating a loading of the antenna exceeding a threshold value or the loading of the antenna being below a threshold value. The transmit power can be selected so as to inversely correlate to the loading characteristic of the antenna.

The present invention also relates to a communication device. The communication device can include an antenna, a first transmitter operatively coupled to the antenna, and a second transmitter operatively coupled to the antenna. The communication device also can include a processor that controls a transmit power of the second transmitter based on at least one parameter that corresponds to a loading characteristic of the antenna. The parameter can be measured on the first transmitter. In one arrangement, the parameter that is measured can be an insertion phase delay, a power compression or a gain of the transmitter. In another arrangement, the parameter can be a voltage standing wave ratio (VSWR) or an amount of signal reflection.

The processor can limit the transmit power of the second transmitter. For example, the processor can limit the transmit power in response to the parameter indicating a loading of the antenna exceeding a threshold value. In another arrangement the processor can selectively change the transmit power. For example, the processor can change the transmit power in response to the parameter indicating a loading of the antenna exceeding a threshold value or the loading of the antenna being below a threshold value. The processor also can select a transmit power that inversely correlates to the loading characteristic of the antenna.

In one aspect of the invention, the processor can be a second processor and the communication device can further include a first processor. The first processor can generate an antenna load indicator based on the parameter and communicate the antenna load indicator to the second processor. The communication device further can include an inter-processor communications link communicatively linking the first processor and the second processor. The first processor can communicate the antenna load indicator to the second processor over the inter-processor communications link.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a block diagram of a communication device that is useful for understanding the present invention;

FIG. 2 is a flowchart that is useful for understanding the present invention; and

FIG. 3 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for selectively controlling a transmit power of a communication device that includes a plurality of transmitters operatively coupled to an antenna. On a first of the transmitters, at least one parameter corresponding to a loading characteristic of the antenna can be measured. Based on the measured parameter, the transmit power of a second transmitter, which also may be operatively coupled to the antenna, can be controlled. For example, if the measured parameter indicates that the antenna is operating in an environment that is substantially similar to a free space environment, the second transmitter can transmit at high power, or even maximum power. If, however, the measured parameter indicates that the antenna is loaded beyond a threshold value, the transmit power of the second transceiver can be reduced. In one arrangement, the transmit power can inversely correlate to the loading of the antenna.

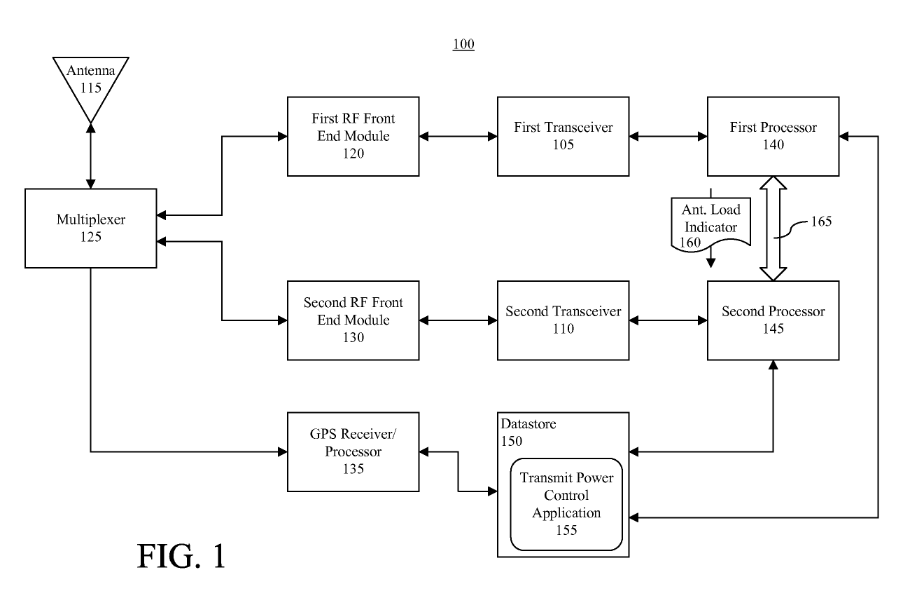

FIG. 1 depicts a block diagram of a communication device 100 that is useful for understanding the present invention. In one arrangement, the communication device 100 can be a mobile station. Examples of mobile stations include, but are not limited to, mobile computers, mobile telephones, mobile radios and personal digital assistants (PDAs). In another arrangement, the communication device 100 can be a cordless telephone.

The communication device 100 can include a plurality of transmitters. For example, the communication device 100 can include a first transceiver 105 and a second transceiver 110. The first and second transceivers 105, 110 can communicate using any suitable wireless communications protocols. Examples of such protocols include IEEE 802 wireless communications, WPA, WPA2, GSM, TDMA, CDMA, WCDMA and WiMax, although the invention is not limited in this regard. Further, the first and second transceivers 105, 110 can support interconnect and/or dispatch communications.

The first transceiver 105 and the second transceiver 110 each can be operatively coupled to an antenna 115. For example, the first transceiver 105 can be operatively coupled to the antenna 115 via a first RF front end module 120 and a multiplexer 125. Similarly, the second transceiver 110 can be operatively coupled to the antenna 115 via a second RF front end module 130 and the multiplexer 125.

The multiplexer 125 can multiplex signals communicated between the antenna 115, the first RF front end module 120, the second RF front end module 130, and any other components which communicate via the antenna 115, for instance a GPS receiver/processor 135. The multiplexer 125 can be, for example, a triplexer. In one aspect of the invention, the multiplexer 125 can include a high pass filter for passing communication signals to and from the first RF front end module 120, a low pass filter for passing communication signals to and from the second RF front end module 130, and a bandpass filter for passing communication signals to the GPS receiver/processor 135.

In one arrangement, the first transceiver 105 can communicate in accordance with the CDMA protocol. In such an arrangement, the first RF front end module 120 can comprise a duplexer that passes receive signals from the multiplexer 125 to the first transceiver's receiver, and passes transmit signals generated by the first transceiver's transmitter to the multiplexer 125. Similarly, if the second transceiver 110 communicates in accordance with CDMA, the second RF front end module 130 can comprise a duplexer.

In another arrangement, the first transceiver 105 can communicate in accordance with TDMA or WiMax. In such an arrangement the first RF front end module 120 can comprise a switch. When the first transceiver 105 is transmitting RF signals, the switch can communicate transmit signals from the first transceiver's transmitter to the multiplexer 125. When the first transceiver 105 is receiving RF signals, the switch can communicate receive signals from the multiplexer 125 to the first transceiver's receiver. Likewise, if the second transceiver 110 communicates in accordance with TDMA or WiMax, the second RF front end module 130 can comprise a switch.

Operation of the first transceiver 105 can be controlled by a first processor 140 and operation of the second transceiver 110 can be controlled by a second processor 145. In another arrangement, a single processor can control operation of both the first and second transceivers 105, 110. The first processor 140 can comprise, for example, a central processing unit (CPU), a digital signal processor (DSP), an application specific integrated circuit (ASIC), a programmable logic device (PLD), a plurality of discrete components that cooperate to process data, and/or any other suitable processing device. Similarly, the second processor 145 can comprise a CPU, a DSP, an ASIC, a PLD, a plurality of discrete components that cooperate to process data, and/or any other suitable processing device.

The communication device 100 also can include a datastore 150. The datastore 150 can include one or more storage devices, each of which can include a magnetic storage medium, an electronic storage medium, an optical storage medium, a magneto-optical storage medium, and/or any other storage medium suitable for storing digital information. In one arrangement, the datastore 150 can be integrated into the first processor 140 or the second processor 145.

A transmit power control application (hereinafter “application”) 155 can be contained on the datastore 150. The application 155 can be executed by the processor 140 and/or the processor 145 to implement the methods and processes described herein. For example, at the behest of the first processor 140 at runtime, one or more transmission parameters can be measured on the first transceiver 105. The parameters can correspond to loading characteristics of the antenna 115.

In one arrangement, transmitter training parameters measured on the first transceiver 105 can be processed to estimate loading characteristics of the antenna 115, for example by measuring an insertion phase delay, a power compression point and/or a gain of the transmitter. In order to determine the insertion phase delay, a constant phase signal (e.g. a phase train squiggle) can be applied to the input of the transmitter and the output can be sampled. The insertion phase can be identified as a phase difference between the input and output signals. In order to determine the power compression point, the transmitter's input power can be ramped linearly (e.g. with a full train amplitude ramp). The transmitter's output can be sampled to determine the point at which the relationship between input and output power changes and measure compression. The transmitter's gain also can be measured in this manner. In another arrangement, the transmitter's gain can be measured by applying an input signal to the input of the transmitter and sampling the transmitter's output. For example, a small scale amplitude train which has constant phase, but is not necessarily ramped linearly (e.g. a pseudo train ramp) can be applied to measure gain of the transmitter. All these parameters typically vary depending on antenna loading.

In another arrangement, a voltage standing wave ratio (VSWR) of the antenna 115 can be measured or an amount of signal reflection can be measured. Nonetheless, the invention is not limited in this regard and other suitable parameters indicative of the loading characteristics of the antenna 115 can be processed.

The first transceiver 105 can include any of a plurality of measuring devices known in the art for measuring transmission parameters on the transceiver 105. Such devices can include, for example, devices that measure signals in the time domain, such as voltage sensors, current sensors, power sensors, and the like, and/or devices that measure signals in the frequency domain, such as a sensor that measures VSWR with respect to frequency.

An antenna load indicator (hereinafter “indicator”) 160 can be communicated from the first processor 140 to the second processor 145, for instance over an inter-processor communications link 165. If the measured parameters indicate that the antenna 115 is operating essentially in free space, the indicator 160 can indicate that the antenna 115 is unloaded. If, however, the measured parameters indicate that the antenna is not operating in free space, for example the antenna 115 is proximate to an object or person, the indicator 160 can indicate that the antenna 115 is loaded. In one aspect of the invention, the indicator 160 can be set to indicate whether the antenna 115 is loaded beyond or below a threshold value. For example, the indicator 160 can indicate the antenna 115 is loaded if the loading of the antenna exceeds a threshold value, and indicate the antenna 115 is unloaded if the loading of the antenna is below a threshold value. In another aspect of the invention, the indicator 160 can indicate a level of antenna loading.

If the indicator 160 indicates that the antenna 115 is loaded, the second processor 145 can limit the transmit power of the second transceiver 110, for example to a pre-determined value. If the indicator 160 indicates that the antenna 115 is unloaded, the second processor 145 can signal the second transceiver 110 to transmit at maximum power. In another arrangement, if the indicator 160 indicates a level of antenna loading, the second processor 145 can select a transmit power that inversely correlates to a loading of the antenna 115.

If the indicator 160 changes, the second processor 145 can signal the second transceiver 110 to change its transmit power. For example, if the indicator 160 changes from indicating that the antenna 115 is loaded to indicating that the antenna 115 is unloaded, the second processor 145 can signal to the second transceiver 110 to change its transmit power to a maximum value. If, however, the indicator 160 changes from indicating that the antenna 115 is unloaded to indicating that the antenna 115 is loaded, the second processor 145 can signal to the second transceiver 110 to reduce its transmit power. Similarly, if the indicator 160 indicates that the loading of the antenna 115 has increased, the second processor 145 can signal to the second transceiver 110 to decrease its transmit power, and if the indicator 160 indicates that the loading of the antenna 115 has decreased, the second processor 145 can signal to the second transceiver 110 to increase its transmit power.

The second processor 145 can indicate transmit power settings for the second transceiver 110 in any suitable manner. For instance, the second processor 145 can indicate transmit gain to be used by the second transceiver 110 or the second processor 145 can control the amplitude of a signal being input into the second transceiver 110. Still, the transmit power can be controlled in any other suitable manner and the invention is not limited in this regard.

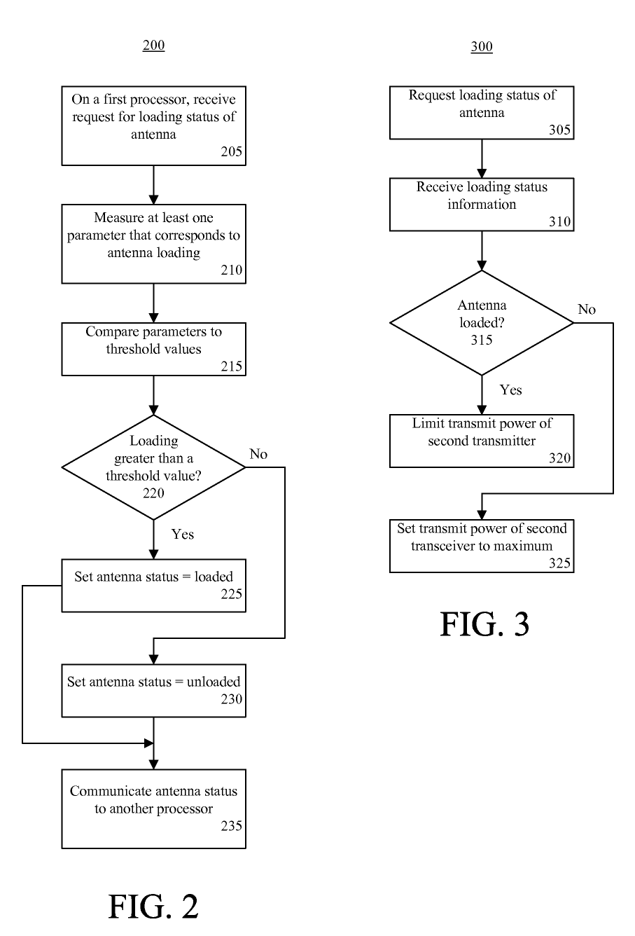

FIG. 2 is a flowchart presenting a method 200 that is useful for understanding the present invention. Beginning at step 205, the first processor can receive a request for information relating to the loading status of the antenna. At step 210, at least one parameter that corresponds to antenna loading can be measured. For example, as noted, a phase train squiggle, a pseudo train ramp, and/or a full train amplitude ramp can be measured. In another arrangement, a voltage standing wave ratio (VSWR) of the antenna can be measured, an amount of signal reflection can be measured, or an amplifier compression can be measured.

Proceeding to step 215, the measured parameters can be compared to threshold values. In one arrangement, the threshold values can be anticipated values of the parameters if such parameters were measured with the antenna operating in free space. In another arrangement, the threshold values can be within a certain tolerance of the free space values.

Referring to decision box 220, if the comparison of the measured parameters to the threshold values indicates that the antenna is loaded beyond the threshold value, at step 225 the status of the antenna can be set to “loaded.” If, however, the comparison does not indicate that the antenna is loaded beyond the threshold value, at step 230 the status of the antenna can be set to “unloaded.” At step 235 the antenna status can be communicated to another processor, for instance the second processor.

FIG. 3 is another flowchart presenting a method 300 that is useful for understanding the present invention. At step 305, the second processor can request loading status of the antenna. For example, such request can be communicated to the first processor. At step 310, the second processor can receive the loading status information from the first processor.

Referring to decision box 315, if the status indicates that the antenna is loaded, at step 320 the transmit power of the second transmitter can be limited. If, however, the status indicates that the antenna is unloaded (e.g. operating in free space or an environment substantially similar to free space), at step 325 the transmit power of the second transceiver can be set to maximum.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method of controlling transmit power of a communication device, comprising:
on a first transmitter, measuring at least one parameter that corresponds to a loading characteristic of an antenna operatively coupled to the first transmitter; and
based on the measured parameter, selectively controlling the transmit power of a second transmitter that is operatively coupled to the antenna.

2. The method of claim 1, wherein controlling the transmit power of the second transmitter comprises limiting the transmit power.

3. The method of claim 2, wherein the transmit power is limited in response to the at least one parameter indicating a loading of the antenna exceeding a threshold value.

4. The method of claim 2, wherein controlling the transmit power of the second transmitter comprises selectively changing the transmit power.

5. The method of claim 4, wherein controlling the transmit power comprises changing the transmit power in response to the at least one parameter indicating a loading of the antenna exceeding a threshold value or the loading of the antenna being below a threshold value.

6. The method of claim 4, wherein controlling the transmit power comprises selecting a transmit power that inversely correlates to the loading characteristic of the antenna.

7. The method of claim 1, wherein measuring at least one parameter comprises measuring an insertion phase delay, a power compression or a gain of the transmitter.

8. The method of claim 1, wherein measuring at least one parameter comprises measuring a voltage standing wave ratio (VSWR) or an amount of signal reflection.

9. The method of claim 1, further comprising:
generating an antenna load indicator based on the at least one parameter; and
communicating the antenna load indicator from a first processor operatively coupled to the first transmitter to a second processor operatively coupled to the second transmitter.

10. A communication device, comprising:
an antenna;
a first transmitter operatively coupled to the antenna;
a second transmitter operatively coupled to the antenna; and
a processor that controls a transmit power of the second transmitter based on at least one parameter that corresponds to a loading characteristic of the antenna, the parameter measured on the first transmitter.

11. The communication device of claim 10, wherein the processor limits the transmit power of the second transmitter.

12. The communication device of claim 11, wherein the processor limits the transmit power in response to the at least one parameter indicating a loading of the antenna exceeding a threshold value.

13. The communication device of claim 11, wherein the processor selectively changes the transmit power.

14. The communication device of claim 13, wherein the processor changes the transmit power in response to the at least one parameter indicating a loading of the antenna exceeding a threshold value or the loading of the antenna being below a threshold value.

15. The communication device of claim 13, wherein the processor selects a transmit power that inversely correlates to the loading characteristic of the antenna.

16. The communication device of claim 10, wherein the at least one parameter that is measured is an insertion phase delay, a power compression or a gain of the transmitter.

17. The communication device of claim 10, wherein the at least one parameter that is measured is a voltage standing wave ratio (VSWR) or an amount of signal reflection.

18. The communication device of claim 10, wherein the processor is a second processor, the communication device further comprising:
a first processor that generates an antenna load indicator based on the at least one parameter and communicates the antenna load indicator to the second processor.

19. The communication device of claim 19, further comprising:
An inter-processor communications link communicatively linking the first processor and the second processor;
wherein the first processor communicates the antenna load indicator to the second processor over the inter-processor communications link.

20. A machine readable storage, having stored thereon a computer program having a plurality of code sections comprising:
code that measures at least one parameter on a first transmitter that corresponds to a loading characteristic of an antenna operatively coupled to the first transmitter; and
code that, based on the measured parameter, selectively controls the transmit power of a second transmitter that is operatively coupled to the antenna.
